(19) United States
(12) Patent Application Publication
(10) Pub. No.: US 2022/0144217 A1
(43) Pub. Date: May 12, 2022

(54) SYSTEM AND A METHOD FOR RAPIDLY CLEARING AN EXTERIOR SENSOR SURFACE ON A VEHICLE

(71) Applicant: DLHBOWLES, INC., CANTON, OH (US)

(72) Inventor: Zachary Downing Kline, Laurel, MD (US)

(21) Appl. No.: 17/525,185

(22) Filed: Nov. 12, 2021

Related U.S. Application Data
(60) Provisional application No. 63/112,812, filed on Nov. 12, 2020.

(51) Int. Cl. B60S 1/54; F16K 11/044; F16K 11/02

(52) U.S. Cl. CPC B60S 1/54; F16K 11/022; F16K 11/044

(57) ABSTRACT

Provided is a system and method for rapidly cleaning a surface utilizing a plurality of quick exhaust valves wherein the system is configured for particularly cleaning large or cylindrically shaped surfaces of sensors mounted to an exterior of a vehicle. The system and method contemplate the use of a plurality of quick exhaust valves arranged with at least one nozzle and at least one solenoid valve to efficiently express a dose of pressurized air onto the surface.

### CROSS REFERENCE TO RELATED APPLICATIONS

This application claims priority to and the benefit from U.S. Provisional patent application No. 63/112,812 filed on Nov. 12, 2020, and titled “System and A Method for Rapidly Clearing an Exterior Sensor Surface on a Vehicle” which is incorporated herein in its entirety.

### FIELD OF INVENTION

The present disclosure generally relates to fluid management systems and methods of effectively removing precipitation or debris from a sensor surface positioned along an exterior of a vehicle.

### BACKGROUND

For as long as there have been vehicles moving around, there has been a need to clean a surface on them for convenience and safety. For example, on today's automobiles there are windshields, rear glass, headlamps, rear cameras, front cameras and a multitude of additional sensors that do not work as effectively when soiled. These sensors can be located all over the vehicle. For many decades the primary need for cleaning has been limited to windshields, rear glass and headlamps.

The rise of Autonomous Vehicle (“AV”) concepts has increased the demand for all types of sensor cleanings. Such sensors can include: cameras, infrared, proximity, and LIDAR, to name a few. They are also typically less effective when occluded with debris. Seeing this as a challenge, many vehicle manufacturers have added a multitude of sensor cleaning options to the vehicle, allowing the operator to clean an exterior facing camera, on-demand from the comfort of the crew compartment. In one embodiment, an on-board computer system decides when cleaning is necessary and triggers an independent cleaning event. The architecture of these sensor cleaning implementations is similar to cleaning a windshield, with several important distinctions. The first is that there is no mechanical cleaning of the surface in the form of a wiper arm. An even distribution of the cleaning fluid is now a higher priority due to the lack of mechanical cleaning/distribution afforded by a wiper on a windshield application. The second is the area to be cleaned on such a sensor is orders of magnitude smaller than a windshield. A result of this reality is that significantly less cleaning fluid is required. A typical windshield cleaning nozzle flows nearly 1000 mL/min, while a comparable sensor cleaning nozzle is less than 300 mL/min typically. Additionally, packaging becomes a significant challenge as imbedded sensors are in tight areas and with the case of optical sensors, the nozzle cannot be in the view of the sensor, or degraded sensor performance will result.

U.S. Patent Publications 2014/0060582 and US 2017/0036650, and U.S. Pat. No. 9,992,388 are incorporated by reference in their entireties and illustrate various methods for solving those goals. However, some challenges have arisen as the realities of these tight packages and non-standard vehicle volumes are realized. In some instances, compressed air has been utilized to blow off debris for automotive sensor applications. Some systems have been known to utilize solenoid valves to manage the distribution of air from an air source to nozzles for application to the sensor surface for the removal of debris. In one instance, it is known to incorporate a type of quick exhaust valve as taught by US Published Patent application 2020/0282416, to rapidly exhaust a closed volume of compressed air onto a surface for the purpose of removing liquid droplets or other contaminants from the surface. However, this disclosure contemplates an assembly for distributing both a compressed air and a fluid from the nozzle assembly to clean a surface.

These known compressed air system are limited because of various factors that are detrimental to the market acceptance of such systems. For example, the high rate of air consumption required for effective removal of precipitation is prohibitive because these air dosing systems require multiple solenoids or large-sized, comparatively expensive solenoids to clear larger sensor surfaces like LIDAR sensor surfaces. There is also a challenge to incorporate multiple nozzles in a design that can be timed to effectively remove debris in an inconspicuous manner by being relatively small, cost effective, and can remove debris from a large or curved surface.

### SUMMARY OF THE DISCLOSURE

In one embodiment, disclosed is a system for rapidly cleaning a surface along an exterior of a vehicle comprising at least one exhaust valves wherein the exhaust valve includes: a housing that defines a cavity with an inlet port, a dose port, and an outlet port; a dose chamber in communication with the dose port; and a valve member placed within the cavity and configured to selectively communicate air pressure between the inlet port, the dose port, and the outlet port, wherein the valve member is configured to bias between a closed position and an open position, the cavity is divided into separate volumes by the valve member such that the selective bias of the valve member between the open and closed positioned allows pressurized air to be stored in the dose chamber and controlled to be expressed through the outlet port. At least one nozzle in communication with the outlet port from the exhaust valve configured to express pressurized air onto a surface to be cleaned; and a changeover valve in communication with the exhaust valve wherein the changeover valve is configured to selectively introduce pressurized air to said at least one exhaust valve and to selectively bias the valve member between the open and closed positions. A plurality of exhaust valves may be provided in the system that are in pressurized communication with a single changeover valve wherein each of the exhaust valves are in pressurized communication with at least one nozzle. The surface to be cleaned may have a generally cylindrical shape or may be curved or flat. The generally cylindrical shape of the surface to be cleaned may includes a height between about 25 mm to about 150 mm and a diameter of about 50 mm to about 300 mm. The dose port may be attached to a dose chamber that is a separate volume continuous within the housing wherein the dose chamber is within the cavity of the housing. Alternatively, the dose port may be attached to a dose chamber that is a separate volume attached to the housing and outside of the cavity of the housing. As the valve member is in the closed position, pressurized air may not be expressed from the outlet port but may be openly communicated between the inlet port and the dose port and when the valve member in the open position, pressurized air may be expressed from the dose port through the outlet port and not communicated with the inlet port. The exhaust valve may be configured for rapid venting through the changeover valve to achieve quick opening of the valve member to release pressurized air from the dosing chamber to the outlet port. The changeover valve may be a 3/2 solenoid valve such that the rapid venting is achieved through the solenoid valve.

In one embodiment, at least one backflow valve may be in communication with at least one dose chamber and a source of pressurized air to allow for the rapid transfer of pressure from the source of pressurized air to the dosing chamber of said at least one exhaust valve when the valve member is in the closed position and the backflow valve is in the open position. Further, at least one backflow valve may be in communication between at least one dose chamber or at least one nozzle and a source of pressurized liquid to allow for the rapid transfer of pressured liquid to be mixed with pressurized air in said dose chamber or said nozzle.

In one embodiment, the plurality of exhaust valves are arranged in a series configuration relative to one another. The plurality of exhaust valves may include a first exhaust valve and at least one subsequent exhaust valve connected to the first exhaust valve through a system of tubes or lumens, the system may further comprise a first backflow valve in communication between at least one dose chamber of the at least one subsequent exhaust valve and the changeover valve such that the first backflow valve is configured to allow said dose chamber to be filled with pressurized air by a source of pressurized air when the changeover valve is open. A second backflow valve may be provided in communication between at least one inlet port of the at least one subsequent exhaust valve and the changeover valve such that the second backflow valve is configured to allow pressurized air into the at least one subsequent exhaust valve when the solenoid valve is open to toggle the valve member of the at least one subsequent exhaust valve in the closed position to allow the at least one dose chamber to be filled with pressurized air.

In another embodiment, the plurality of exhaust valves are arranged in a waterfall configuration relative to one another. The waterfall configuration includes a first exhaust valve and at least one subsequent exhaust valve such that the dosing chamber of the first exhaust valve is in fluid communication with the inlets port of the subsequent exhaust valve and are configured to route pressurized air from said inlet port of said subsequent exhaust valve to said dose chamber of the first exhaust valve. This embodiment may include a first backflow valve in communication between a dose chamber of a first exhaust valve, the changeover valve, the inlet port of the first exhaust valve and a second backflow valve in communication between a dose chamber of at least one subsequent exhaust valve, an inlet port of at least one subsequent exhaust valve wherein the first and second backflow valves allow the dose chambers to be filled with pressurized air by the air source when the changeover valve is opened. Here, as the changeover valve is closed, the pressure within the dose chambers is configured to bias the valve members of the plurality of exhaust valves to the open position and exhaust pressurized air through the nozzles and against the desired surface. Pressurized air within the subsequent exhaust valve may be configured to be rapidly exhausted from the inlet port of the subsequent exhaust valve to the dose chamber of the first exhaust valve, and pressurized air within the dose chamber of the first exhaust valve is configured to be rapidly exhausted from the outlet port.

In another embodiment, the system to is configured to provide a plurality of exhaust air bursts or pulsed air bursts from the at least one nozzle to clean a surface. Here, between each of the plurality of pulsed air bursts, the dose chamber of the exhaust valve may be filled with pressurized air to a static pressure and then the pressurized air may be only partially exhausted from said dose chamber. The system may further include at least one of the following design features: an average mass flow rate of each pulsed air burst is at least about 0.5 g/s; a nozzle outlet velocity is greater than about 50 m/s; and a target system thrust of that is greater than about 0.025 N. In another embodiment, the system further comprises at least one of the following design features: (a) the at least one nozzle includes at least one outlet having a cross sectional area wherein the cross sectional area of the at least one outlet is greater than a cross sectional flow area of the changeover valve; (b) at least one tube connected between the exhaust valve and the at least one nozzle, wherein the tube includes a cross sectional area such that the cross sectional area of the tube is about 2 times a sum of the cross sectional area of the at least one outlet of the at least one nozzle; (c) the outlet port of the exhaust valve has a cross sectional area that is greater than the cross sectional area of said tube connected between the exhaust valve and the at least one nozzle; and (d) an absolute pressure in the dose chamber does not drop below about 2 times an ambient pressure as pressurized air is being exhausted from the dose chamber between exhaust air bursts.

In one embodiment, provided is a method of rapidly cleaning a surface utilizing a plurality of quick exhaust valves and a plurality of nozzles comprising: providing at least one exhaust valve wherein the exhaust valve includes: a housing that defines a cavity with an inlet port, a dose port, and an outlet port; a dose chamber in communication with the dose port; and a valve member placed within the cavity and configured to selectively communicate air pressure between the inlet port, the dose port, and the outlet port, wherein the valve member is configured to bias between a closed position and an open position, the cavity is divided into separate volumes by the valve member such that the valve member is configured to be selective biased between the open and closed positions; providing at least one nozzle in communication with the outlet port from at least one of the plurality of exhaust valves configured to express pressurized air onto a surface to be cleaned; providing a changeover valve in communication with the at least one exhaust valves; and controlling the changeover valve to selectively introduce pressurized air to said at least one exhaust valve and to selectively bias the valve member between the open and closed positions to operate said exhaust valves in a truncated cycle operation to provide a plurality of exhaust air bursts or pulsed air bursts from the at least one nozzle to clean a surface.

### DESCRIPTIONS OF THE DRAWINGS

These, as well as other objects and advantages of this disclosure, will be more completely understood and appreciated by referring to the following more detailed description of the presently preferred exemplary embodiments of the invention in conjunction with the accompanying drawings, of which:

FIG. 1A is schematic diagram of a quick exhaust valve known in the art;

FIG. 1B is a valve member for a quick exhaust valve of FIG. 1A;

FIG. 2 is a schematic diagram of an embodiment of a system for rapidly cleaning a surface according to the present disclosure;

FIG. 3 is a schematic diagram of an embodiment of a system for rapidly cleaning a surface according to the present disclosure;

FIG. 4 is a schematic diagram of another embodiment of a system for rapidly cleaning a surface according to the present disclosure;

FIG. 5 is a schematic diagram of another embodiment of a system for rapidly cleaning a surface according to the present disclosure;

FIG. 6 is a schematic diagram of a quick exhaust valve with a backflow valve for use in a system for rapidly cleaning a surface according to the present disclosure;

FIG. 7 is a schematic diagram of another embodiment of a system for rapidly cleaning a surface according to the present disclosure;

FIG. 8 is a schematic diagram of another embodiment of a system for rapidly cleaning a surface according to the present disclosure;

FIG. 9 is a schematic diagram of another embodiment of a system for rapidly cleaning a surface according to the present disclosure;

FIG. 10 is a schematic diagram of another embodiment of a system for rapidly cleaning a surface according to the present disclosure;

FIG. 11A is an image of a surface of a large cylindrical sensor with precipitation thereon surrounded by nozzles of a system for rapidly cleaning a surface according to the present disclosure;

FIG. 11B is an image of the surface of FIG. 11A having precipitation thereon removed by the system for rapidly cleaning a surface according to the present disclosure;

FIG. 12 is an image of an embodiment of a system for rapidly cleaning a surface according to the present disclosure;

FIG. 13 is a graph illustrating pressure versus time during the operation of an embodiment of the system for rapidly cleaning a surface according to the instant disclosure;

FIG. 14 is a graph illustrating pressure versus time during the operation of an embodiment of the system for rapidly cleaning a surface according to the instant disclosure;

FIG. 15 is a graph illustrating pressure versus time that illustrates valve chatter during the operation of an embodiment of the system for rapidly cleaning a surface according to the instant disclosure;

FIG. 16 is a perspective schematic illustration of a low efficiency nozzle type that may be used in the system for rapidly cleaning a surface according to the instant disclosure; and

FIG. 17 is a perspective schematic illustration of a high-efficiency nozzle type that may be used in the system for rapidly cleaning a surface according to the instant disclosure;

### DETAILED DESCRIPTION

Reference will now be made in detail to exemplary embodiments of the present teachings, examples of which are illustrated in the accompanying drawings. It is to be understood that other embodiments may be utilized and structural and functional changes may be made without departing from the respective scope of the present teachings. Moreover, features of the various embodiments may be combined or altered without departing from the scope of the present teachings. As such, the following description is presented by way of illustration only and should not limit in any way the various alternatives and modifications that may be made to the illustrated embodiments and still be within the spirit and scope of the present teachings. In this disclosure, any identification of specific shapes, materials, techniques, arrangements, etc. are either related to a specific example presented or are merely a general description of such a shape, material, technique, arrangement, dimension etc.

It is an objective of this disclosure to provide a system and method of fluid management to effectively and efficiently remove precipitation or debris from a sensor surface positioned along an exterior of a vehicle. There is a desire to reduce the quantity of compressed air needed to clear water droplets from a sensor surface, especially larger surfaces like LIDARs typically mounted to the exterior of a vehicle. Testing has shown that utilizing a system of quick exhaust valves to provide air dosing can reduce the mass of air needed to clear droplets from a given small surface, like an automotive rear view camera versus a short burst of compressed air from a shear nozzle. However, the trouble has always been to correctly arrange a system of dosing type valves or exhaust valves, such as quick exhaust valves (“QEV”) in a manner that correctly operates to clear a large surface of debris.

Further, known systems have not been able to effectively clean large surfaces or cylindrical surfaces such as those incorporated in certain LIDAR sensors that are contemplated to be used on vehicles to assist with automation. These large or cylindrical LIDAR sensor surfaces are generally larger than camera or other sensor lens surfaces such as those used on rearview cameras of certain vehicles. Such LIDAR sensors are contemplated to be used on cars, trucks, boats, UAVs, planes, or industrial or agricultural equipment. One embodiment of a large shaped cylindrical surface can be measured to have a height of 55 mm and a diameter of 115 mm surface. However, any size and type of surface is contemplated herein but the height and curvature of such a sensor surface directly effects the type of cleaning system that may be implemented for proper clearing. Notably, cylindrical shaped surfaces may be better served to be cleaned by multiple nozzles spaced about the cylindrical shape of such surface to provide fan angle sprays with sufficient shapes and/or overlap of spray to remove precipitation or debris from the surface. Notably, the embodiments of the disclosed system may be configured to clean any type of surface including flat surfaces, slightly curved surfaces such as moderately curved windows or the like.

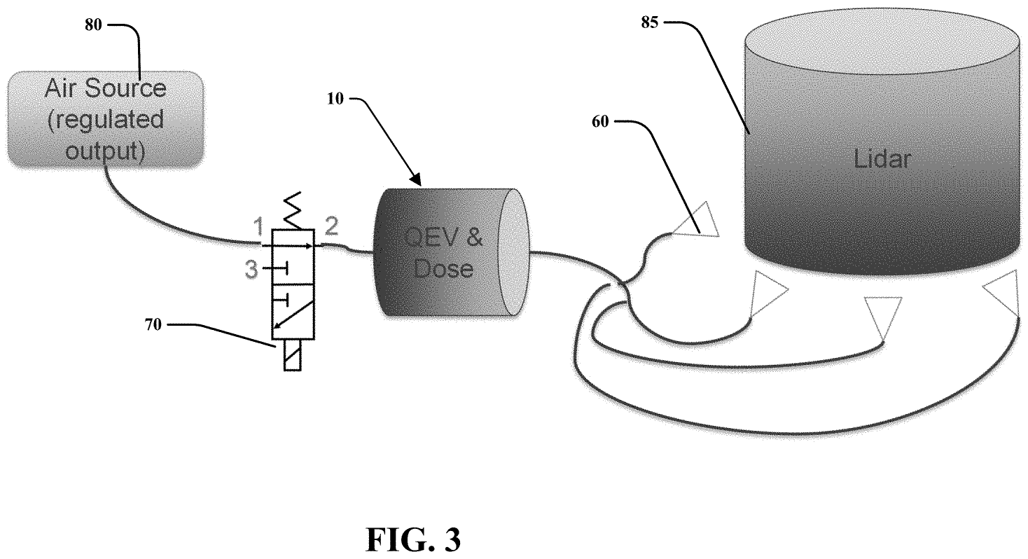

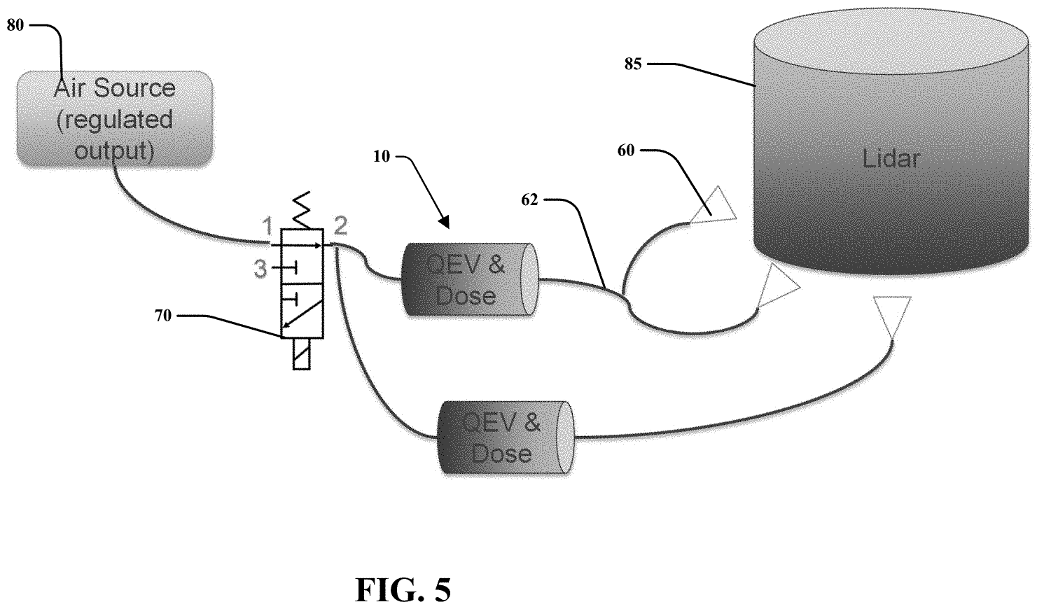

One such design parameter for an effective cleaning system is to establish use of the smallest possible air dose to clean a sensor surface 85 (FIGS. 3 and 5) while being achieved with a minimum number of changeover valves 70 to reduce system cost and complexity thereby establishing the use of a plurality of nozzles 60 per one changeover valve. Changeover valves may be an electromechanically controlled valve wherein one common type of a changeover valve is a solenoid valve. Many types of solenoid valves are prohibitively expensive related to both nozzles as well as QEVs. Additionally, applicant has identified that a 1:1 ratio of solenoid valves to nozzles will generate a non-viable system cost. As such, there are commercial benefits of downsizing the source of compressed air, reducing the size of solenoid valves needed for effective cleaning, and otherwise eliminate the need for using multiple solenoid valves unless multiple nozzles can be controlled by a single solenoid valve for a system as described herein.

Further, there exists design theory that a threshold velocity of compressed air (Vmin) is required to move a droplet of a particular size. Nozzle velocity generated is a function of nozzle geometry and air supplied. Velocity at a distance from the nozzle must exceed Vmin for droplet clearing of a given sensor surface. The QEV meters air flow so that the performance of the spray including volume and speed is not determined by the configuration of the nozzle. The proper utilization of a QEV in such a system should allow a design use of various type of nozzles such as one with a large nozzle outlet. The QEV allows air to rapidly exit without restrictions like a typical nozzle throat, achieving high instantaneous mass flow rate (Qinst) of air but low overall volume of air released per activation. A high mass flow rate Qinst will propagate Vmin further from the nozzle than lower Qinst. Faster dose release times should result in higher Qinst and a velocity V at distance Ymm from the nozzle without increasing the mass of air consumed which should result in a more efficient surface clearing. A nozzle with large fan angle would reduce the number of nozzles needed per sensor surface, but is only effective if Vmin can still be achieved.

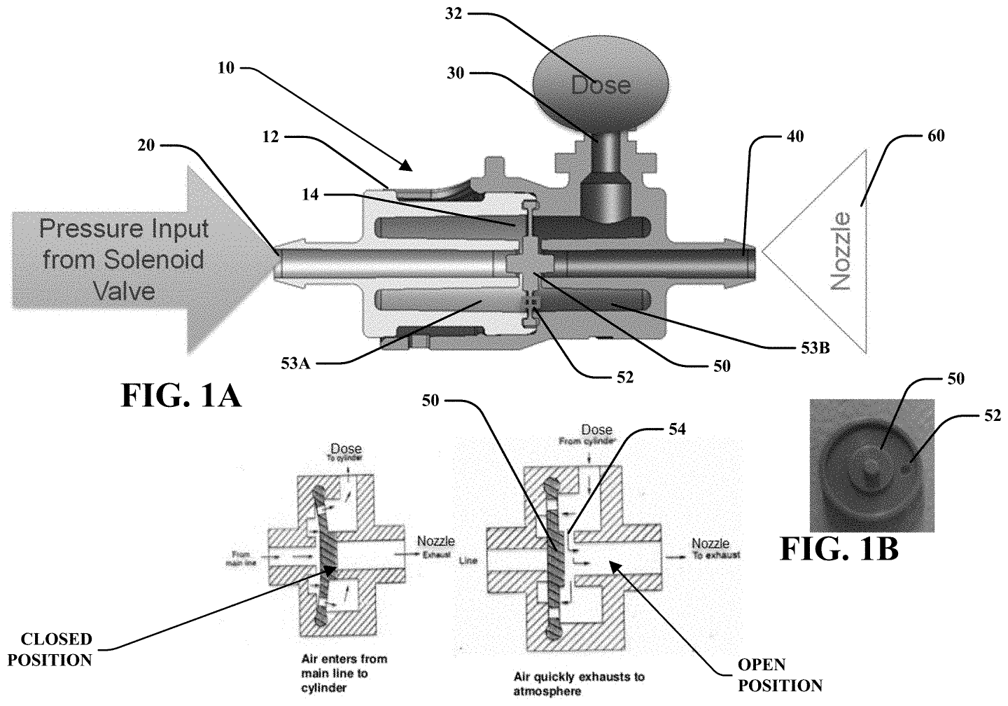

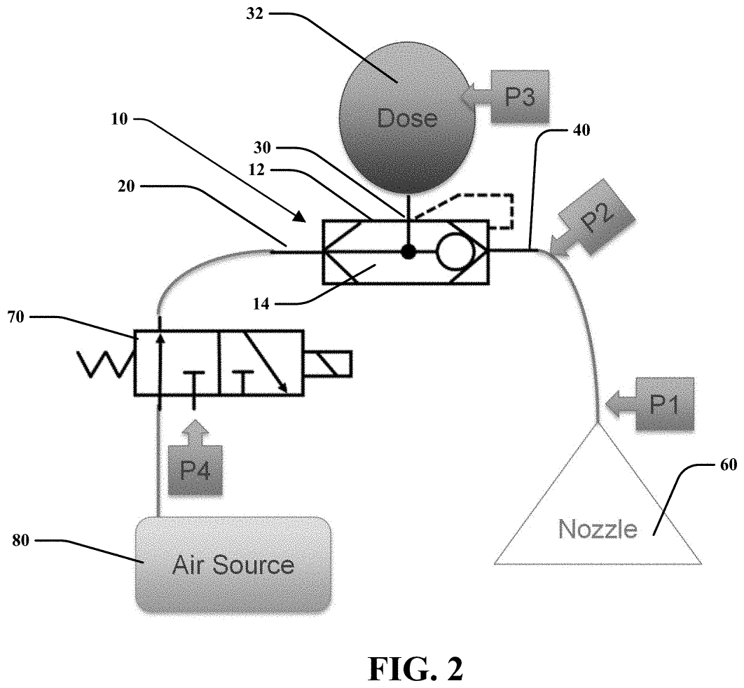

Applicant has addressed the described problems and incorporated the described design theory to discover the embodiments of cleaning systems of this disclosure. FIGS. 1A and 1B illustrate one embodiment of a QEV contemplated by the instant application. The QEV 10 includes a housing 12 that defines a cavity 14 with a first port (inlet) 20, a second port (dose) 30, and a third port (outlet) 40. Notably, the second port (dose) 30 may be a separate volume continuous within the housing 12 wherein the second port and related dose may be within the cavity of the housing or the second port (dose) 30 may be a separate device (as illustrated by FIG. 2) to allow the dose to be attached thereto. A valve member 50 may be placed within the cavity 14 and in operable and selective communication of air pressure between the first, second, and third ports. The valve member 50 may be biased between a closed position and an open position. In the closed position, pressurized air may not be expressed from the third port (outlet) 40 but may be openly communicated between the first port (inlet) 20 and the second port (dose) 30. In the open position, pressurized air may be expressed from the second port (dose) 30 through the cavity 14 and expressed from the third port (outlet) 40 to a nozzle but may not be openly communicated with the first port (inlet) 20. The cavity 14 may be divided into separate volumes by the valve member 50. The separate volumes may be in pressurized communication by the pilot hole 52 in valve member 50. In the embodiment, of FIG. 1A, the QEV includes a valve member 50 with the pilot hole 52 between the first volume 53A and the second volume 53B within the cavity 14. In an embodiment, the selective bias of the valve member between the open and closed positioned allows compressed air to enter into the QEV and be stored in a dose chamber 32 and then controlled to be expressed through the outlet 50 and nozzle 60 in a desired and controlled manner to remove precipitation or debris from a sensor surface.

Stated another way, pressurized air or gas may be applied to the inlet 20 of the QEV pressure from a solenoid valve such that it is directed into the dose chamber 32 while prevented from being expressed from the outlet 50. The valve member 50 may be shaped in a particular manner to allow for this functionality which toggles between open and closed positioned based on line pressure to allow compressed air to be stored in the dose chamber in the closed position and rapidly exhaust from the outlet in the opened position. The valve member 50 may also include a pilot hole 52 to assist with the transfer of pressurized air in the desired manner.

FIG. 2 illustrates a schematic line diagram of an embodiment of a cleaning system that includes a QEV 10 in pressurized communication with a source of compressed air 80, a 3/2 solenoid valve 70 and a nozzle 60. These elements are in pressurized communication by hoses that may be various sizes and lengths. However, this configuration has design limitation in that the control side (first port) of the QEV must be configured for rapid vented through the solenoid valve 70 in order to achieve quick opening of the valve member 50 and in turn the dosing chamber 32 which releases the pressurized dose to the outlet 40. This ability of rapid control line venting allows such a system to achieve a high exit velocity and instantaneous mass flow rate of air from the device, leading to effective droplet clearing. Pressure switching on the control side of the QEV can be achieved with a 3/2 type solenoid valve which connects the QEV either to a compressed air source 80 to charge the dose or to ambient air in order to vent the dose. This arrangement necessitates using one solenoid per QEV, which leads to a high system cost.

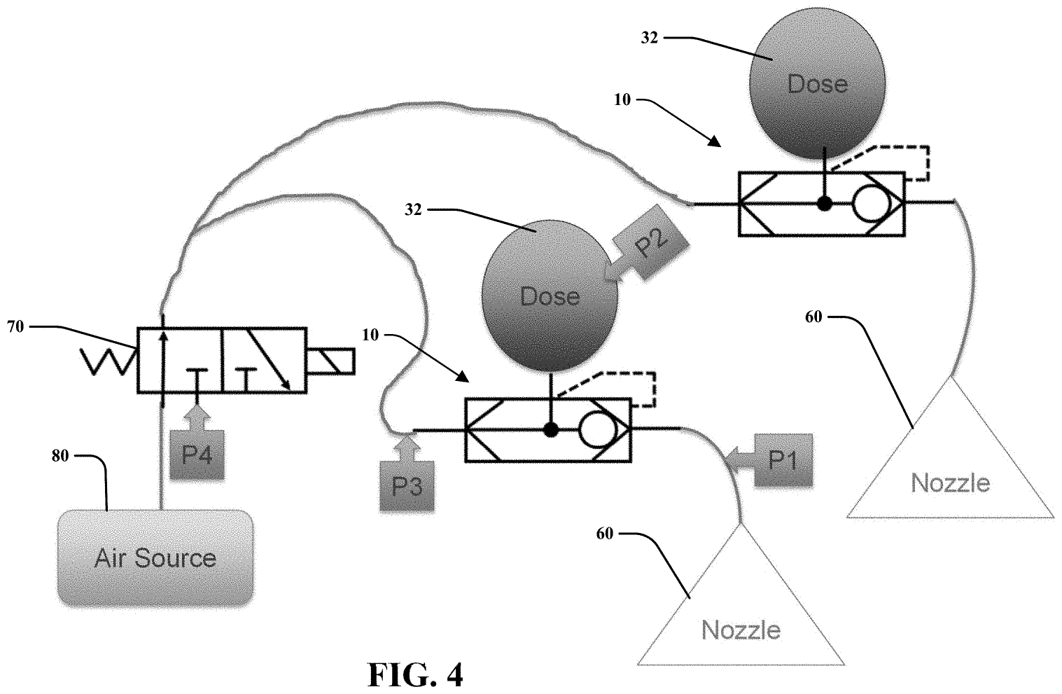

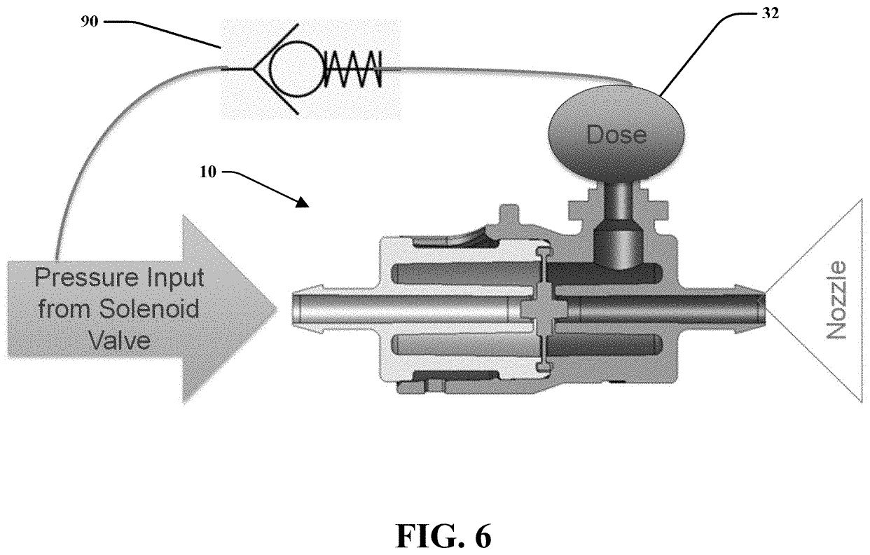

Applicant has discovered that using multiple QEVs per solenoid valve can be achieved if the solenoid valve is adequately sized to rapidly vent the control side of all the QEVs at once as well as any tubing connecting them. This configuration is contemplated by FIGS. 3-5 and requires a large solenoid valve but could include any number of QEVs and nozzles to clean a surface 85. FIG. 6 describes an alternate configuration of the QEV in which at least one additional backflow valve or check valves 90 are introduced to the system in order to allow for the rapid transfer of pressure from both the dose chamber 32 to the outlet port 40 when in the open configuration and the rapid transfer of pressure from the source of pressurized air to the dosing chamber 32 when in the closed position. Additionally, the pilot hole 52 in the valve member 50 is eliminated to prevent backflow from the dose 32 to the solenoid valve 70 vent.

Alternatively, multiple QEVs can be configured as described below to allow efficient function with a single small 3-2 solenoid valve that does not need to be designed to allow for the rapid venting of the plurality of QEVs. In this instance, this disclosure contemplates at least two arrangements (“series” and “waterfall”) configured for a quick QEV air dosing system.

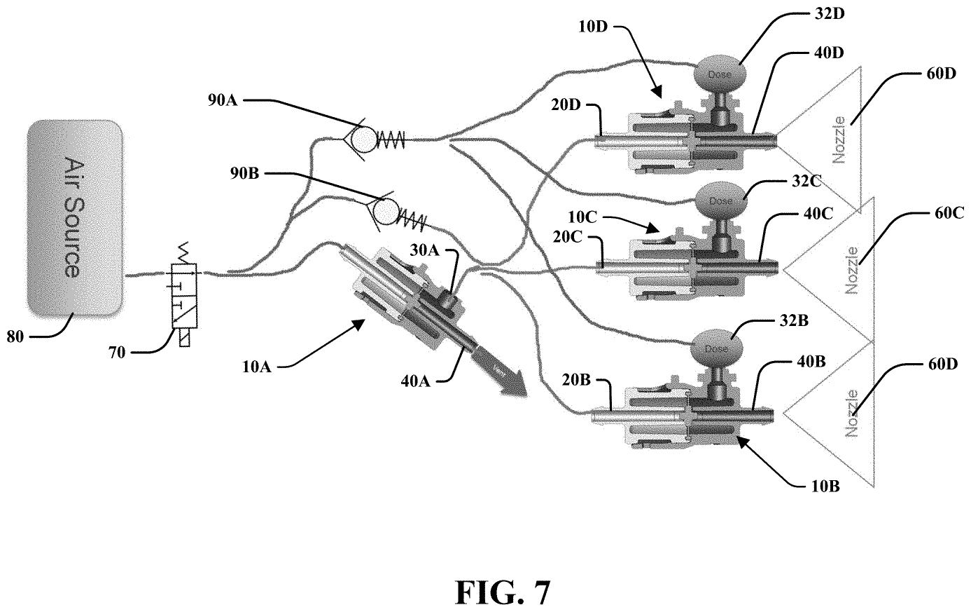

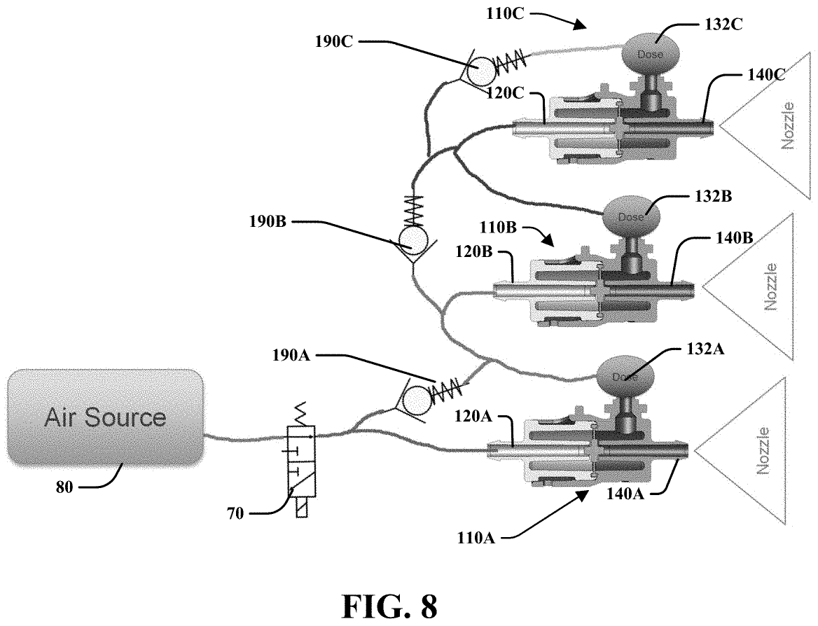

In the configurations contemplated by FIG. 7 (“series”) and FIG. 8 (“waterfall”), at least one additional backflow valve or check valves 90, 190 are introduced to the system in order to allow for the rapid transfer of pressure from both the dose chamber 32 to the outlet port 40 when in the open configuration and the rapid transfer of pressure from the source of pressurized air to the dosing chamber 32 when in the closed position. Both configurations allow for QEVs to be rapidly vented through the control side (first port) in order to operate effectively as a multi-nozzle setup such as is needed to clear a LIDAR sensor surface 85 would otherwise require a very large solenoid valve or multiple solenoids in order to be able to vent quickly enough. This also allows for the efficient and rapid biasing of the valve member 50 between the closed and opened positions to efficiently and effectively time each nozzle spray so that the desired portions of the surface are cleared by each nozzle sufficiently.

In one embodiment, as contemplated by FIG. 7, a plurality of QEVs 10 may be arranged in series such that a first QEV 10A triggers subsequent QEVs 10B, 10C, 10D so that the triggering/controlling solenoid valve 70 can be relatively small in that it does not need to be designed to allow for rapid vending. Instead, the rapid venting is achieved by the use of the first QEV 10A in which its outlet port 40A is directly exhausted to ambient environment. In contrast, the outlet ports 40B, 40C, 40D of subsequent QEVs 10B, 10C, 10D are in communication with nozzles 60A, 60C, 60D, respectively to provide express pressurized air from the related dose chamber 32B, 32C, 32D to the desired surface in a controlled time relative to one another. The first QEV 10A does not include a dose chamber but its second port 30A is in pressurized communication with the inlet ports 20B, 20C, 20D of the subsequent QEVs 10B, 10C, 10D.

In an embodiment as illustrated by FIG. 7, a first backflow valve 90A is in communication with the dose chambers 32B, 32C, 32D of the subsequent QEVs 10B, 10C, 10D. and the solenoid 70. This backflow valve 90A allows the dose chambers to be directly filled with pressurized air by the air source 80 when the solenoid valve 70 is opened. However, once in the dose chamber 32, pressurized air is prevented from being introduced back to the solenoid 70. Additionally, a second backflow valve 90B is in communication with the inlet ports 20B, 20C, 20D of the subsequent QEVs 10B, 10C, 10D as well as the second port 30A from the first QEV 10A and the solenoid valve 70. In this instance, pressurize air is introduced to the system when the solenoid valve is controlled open placing the valve members 50 of each QEV in the closed position and filing the dose chambers with pressurized air. When the solenoid valve 70 is closed, the pressure within the dose chambers 32B, 32C, 32D is greater than the control line side pressure and functions to bias the valve members 50 to the open position and exhaust pressurized air through the nozzles and against the desired surface. Also, latent pressurized air within the QEVs 10B, 10C, 10D is rapidly exhausted from the inlet ports 20B, 20C, 20D and through the second port 30A and outlet port 40A of the first QED 10A. The rapid venting of this latent pressurized air from the QEVs 10B, 10C, 10D allows for the desired volume and speed flow of pressurize air from the dose chambers through the outlets resulting in the desired removal of precipitation from the surface.

Stated another way, the first QEV is configured as a relay to trigger several other QEVs with a single solenoid valve. To do so, the control side of multiple QEVs can be connected to the actuator or dose port of the QEV which is acting as a relay. The doses and control sides of the downstream QEVs should be connected to the 3-2 solenoid valve outlet with one-way check valves that allow compressed air to flow to the doses when the solenoid port is connected to pressure but do not allow air to flow back out of the doses when the solenoid valve is switched to the vent position. In this way, the doses of all the QEVs are filled when the solenoid valve is connected to pressure but when it switches, only the control side of the relay QEV is allowed to vent. This causes the relay QEV to open and vent the pressure from the control side of all the connected QEVs to ambient, allowing them to open and vent their doses onto the target sensor surfaces. The benefit is that the relay QEV vent port can be sized much larger than the solenoid controlling orifice, allowing a large control volume from multiple QEVs to be rapidly vented to ambient. If the same volume were forced through the solenoid valve, the flow would be throttled, preventing rapid opening of the downstream QEVs and limiting air exit velocity from the downstream QEVs. In an alternate configuration, the one-way check valves 90A, 90B and their connecting hosing could be eliminated if pilot holes 52 were present in the valve members 50 allowing pressurized air to fill the doses 32B, 32C, 32D when the solenoid 70 was connected to the air source. Any similar one-way or substantially biased flow path could also be used to fill the doses 32B, 32C, 32D.

In another embodiment, as contemplated by FIG. 8, a plurality of QEVs 110A, 110B, 110C are arranged in a waterfall configuration. The plurality of QEVs 110A, 110B, 110C may be arranged in a cascading series such that the dosing chambers 132A, 132B and the inlets ports 120B, 120C of downstream QEVs are in fluid communication so that the triggering/controlling solenoid valve 70 can be relatively small in that it does not need to be designed to allow for rapid venting of a large volume of air. Instead, the rapid venting of latent pressurized air is achieved by routing inlet port 120C to dose chamber 132B, inlet port 120B to dose chamber 132A, and the inlet port 120A is routed to the solenoid valve 70. The outlet ports 140A, 140B, 140C of QEVs 110A, 110B, 110C are in communication with nozzles to provide express pressurized air from the related dose chambers 132A, 132B, 132C to the desired surface in a controlled time relative to one another.

In the embodiment as illustrated by FIG. 8, an open side of a first backflow valve 190A is in communication with the dose chamber 132A, the solenoid valve 70, the inlet port 120B, and a closed side of a second backflow valve 190B. The open side of the second backflow valve 190B is in communication with the dose chamber 132B, inlet port 120C and a closed side of a third backflow valve 190C. The open side of the third backflow valve 190C is in communication with the dose chamber 132C. The first, second, and third backflow valves 190A, 190B, 190C allow the dose chambers to be directly filled with pressurized air by the air source 80 when the solenoid valve 70 is opened. However, once in the dose chambers are full, pressurized air is prevented from being introduced back to the solenoid 70. In this instance, pressurize air is introduced to the system when the solenoid valve is controlled open placing the valve members 50 of each QEV in the closed position and filing the dose chambers with pressurized air. When the solenoid valve 70 is closed, the pressure within the dose chambers 132A, 132B, 132C is greater than the control line side pressure and functions to bias the valve members 50 to the open position and exhaust pressurized air through the nozzles and against the desired surface. Also, latent pressurized air within the QEV 110C is rapidly exhausted from the inlet port 120C to the dose chamber 132B, latent pressurized air within QEV 110B is rapidly exhausted from inlet port 120B to dose chamber 132A, and latent pressurized air within QEV 110A is rapidly exhausted from inlet port 120A through the solenoid valve 70. The rapid venting of this latent pressurized air from the QEVs 110A, 110B, 110C allows for the desired volume and speed flow of pressurize air from the dose chambers through the outlets resulting in the desired removal of precipitation form the surface.

Stated another way, multiple QEVs are connected in a cascading or avalanche configuration where the control port of each downstream QEV is connected to the dose of the preceding QEV. Triggering the solenoid valve connected to the control side of the first QEV causes it to open and vent its dose, which causes the control port of the next QEV to see ambient pressure and open, venting it and causing the next QEV in line to vent in a cascading fashion. Alternately, instead of each QEV being connected to a single downstream QEV in series with a 1:1 relationship, each QEV could be connected to multiple downstream QEVs in a 1:2 or 1:X ratio to cause an avalanche activation of downstream QEVs. To charge the doses of a cascading QEV configuration, the doses should have a parallel pressure feed path with one-way check valve isolation of each successive QEV so that compressed air can flow to the doses from the compressed air source but is not allowed to flow back to the source.

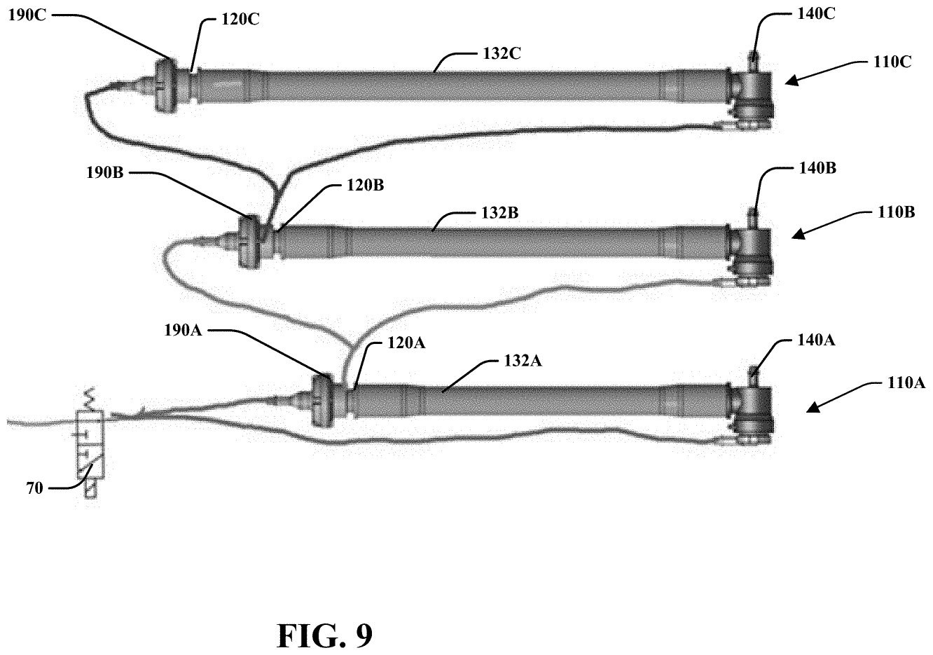

Applicant has identified that chatter may cause failure in the system configured in a cascade or waterfall configuration. This may occur in a system when a vent rate for both the control side and the dose size are similar. There exists several structural variables that can be employed to compensate for chatter failure. In one example, successive dose chambers in the chain of the system could be successively larger. FIG. 9 illustrates an embodiment of the waterfall configuration that is comparable to the configuration of FIG. 8 but includes successive dose chambers that are successively larger volumes. In this embodiment, dose chamber 132C is greater in size than dose chamber 132B which is greater in size than dose chamber 132A. This configuration may extend dose vent time. In another example, tubing connections between dose chambers may include additional volume between each subsequent QEV to increase the size of the storage volume for pressurized air. For example, the tubing between the solenoid valve 70 and the first QEV 110A may be about 5 ml, the tubing between the first QEV 110A and the second QEV 110B may be about 10 ml, the tubing between the second QEV 110B and the third QEV 110C may be about 15 ml, etc. This configuration may extend dose vent time. In yet another example, successive nozzles may be sized with progressively smaller outlet sizes to extend does vent time. Further, each QEV could also communicate to a different number of nozzles to further extend dose vent time. For example, the first QEV 110A may communicate from its outlet port 140A to 3 nozzles, the second QEV 110B may communicate from its outlet port 140B to 2 nozzles, and the third QEV 110C may communicate from its outlet port 140C to 1 nozzle.

Notably, such timed expression of compressed air from each of the subsequent nozzles is not exactly simultaneously performed as there is a subtle time delay between each expression. The subtle time delay is not necessarily noticeable to the human eye but otherwise effectively removes the debris from the desired portion of the surface in rapid succession. Duration of the pulse between subsequent QEV outlets and nozzles is primarily dependent on the dose size and its pulse duration may be lengthened slightly by longer hoses used in the system. However, one embodiment of the pulse time has been measured to exist between about 0.03s to about 0.18s from each nozzle.

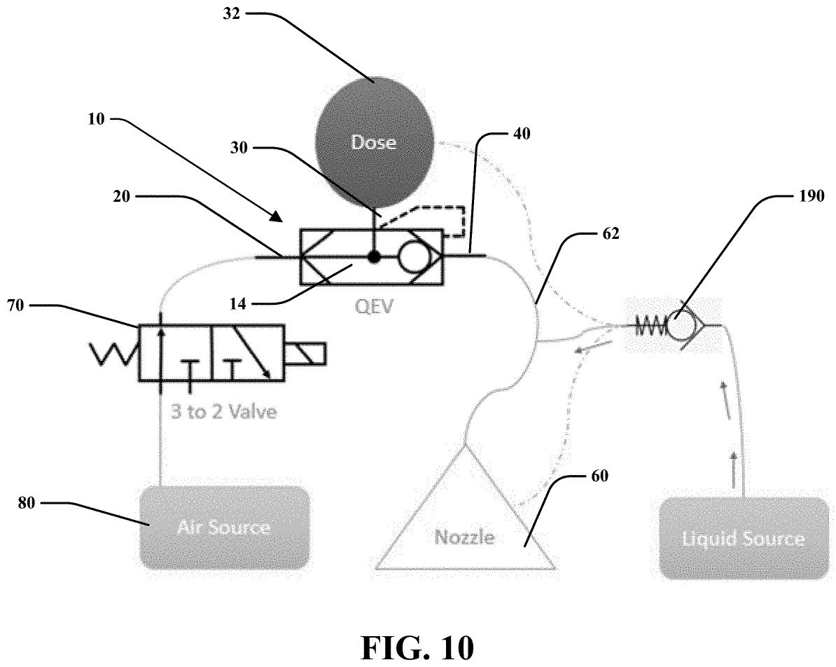

FIG. 10 illustrates another embodiment further comprising at least one backflow valve 190 in communication between at least one dose chamber 32 or at least one nozzle 60 and a source of pressurized liquid 200 to allow for the rapid transfer of pressured liquid to be mixed with pressurized air in said dose chamber 32 or said nozzle 60. Notably, this wet air cleaning feature can be an alternate embodiment of the system disclosed herein. Liquid, such as a washer fluid, may be injected to the dose chamber 32 and the nozzle 60 or into the nozzle while the dose chamber 32 is depressurized. Pressurized air may then be introduced into the QEV 10 and the backflow valve 190 would prevent pressurized air from entering the liquid hoses or the liquid source 200. The solenoid valve 70 may be a 3/2 valve and when it is toggled between closed to opened positioned, venting of the control side of the system may occur and allow fluid to be mixed presented within the dose chamber 32. Once the pressurized air is introduced into the dose chamber and mixed with the fluid, the QEV may be configured to vent both air and fluid from the dose chamber through the nozzle 60 and onto a surface to be cleaned.

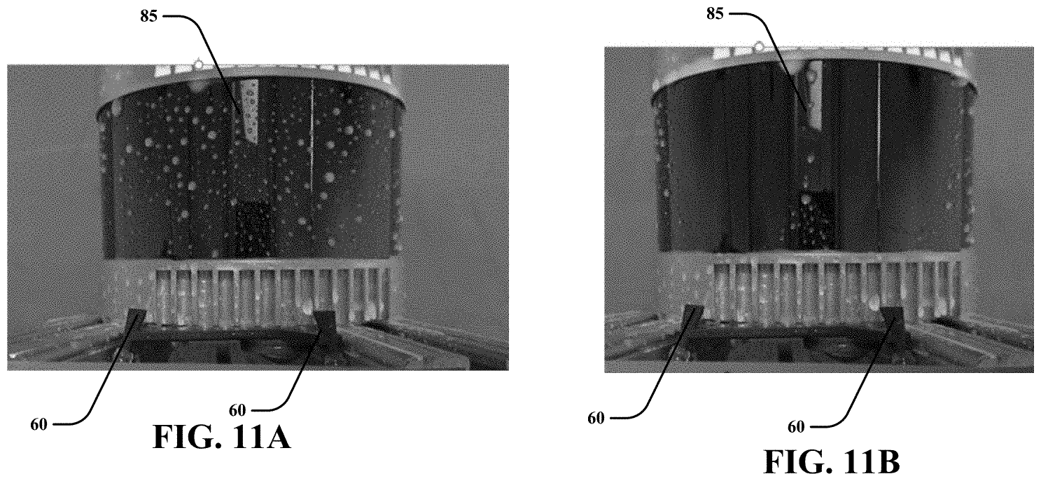

The cleaning of a surface such as the removal of precipitation is illustrated by FIGS. 11A and 11B wherein a large LIDAR sensor surface having a generally cylindrical shape is illustrated with a system of the instant disclosure. Here, 2 nozzles are positioned along the outer curvature of the surface to be cleaned. FIG. 11A illustrates the surface having the precipitation thereon. FIG. 11B illustrates the surface having the precipitation removed by expressing compressed air form the two nozzles from different points positioned about the curvature of the cylindrical shaped surface. The generally cylindrical shape of a LIDAR surface or other surface to be cleaned may include a height between about 25 mm to about 150 mm and a diameter of about 50 mm to about 300 mm.

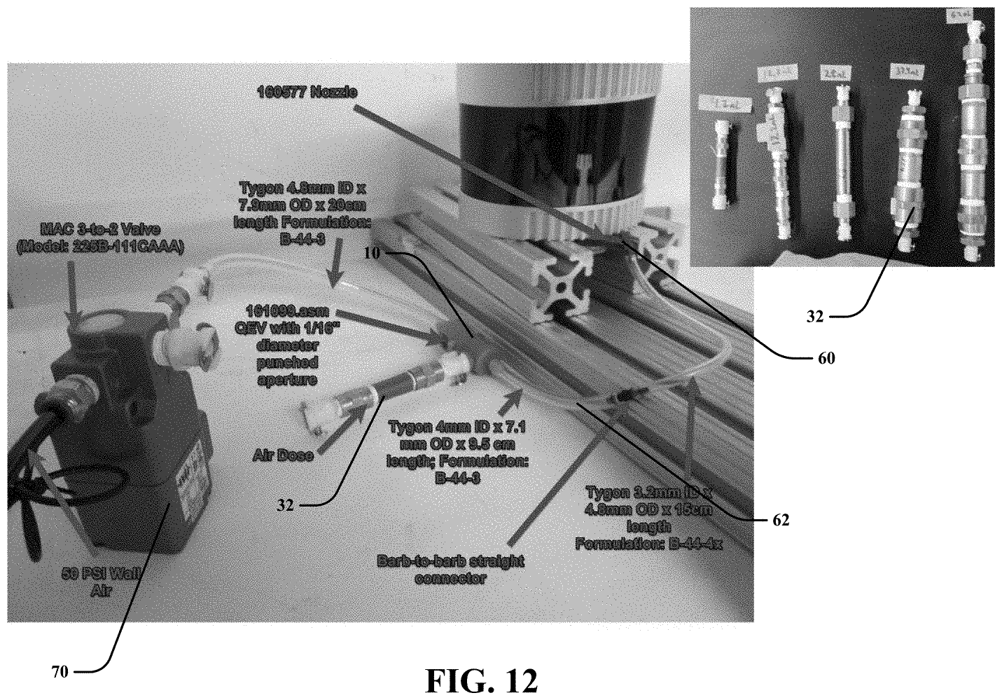

FIG. 12 is an image of a test setup used to establish the desired clean results having dose chambers 32 of various sizes. Additionally, the disclosed embodiments are contemplated to utilize a dose chamber 32 having a volume of between about 4 mL and about 400 mL. Preliminary tests of the embodiments have demonstrated that higher outlet velocities exist for larger sized doses wherein a 37.4 mL dose may provide an average nozzle outlet velocity of about 260 m/s. In one embodiment, the threshold velocity for clearing at a droplet location along a surface is likely to be about 5 m/s to about 30 m/s. In another embodiment, the range of threshold velocity may be about 150 m/s to about 250 m/s. It was observed that significant outlet velocities can be achieved even with very low nozzle pressures.

Notably, applicant has discovered that certain efficiencies may be streamlined relating to pressure equalization within the systems described herein. More particularly, it may be required for the system to function cyclically by providing a plurality of exhaust air bursts or pulsed air bursts to properly clean a surface. Such a cycle of pulsed air burst can occur quite rapidly to allow the surface to be cleaning quickly such as be between 1 to 5 seconds (this range is non-limiting as any duration of cyclical operation is contemplated herein). Further, each cycle will require that the dose chambers of each of the plurality of QEVs in the system, however arranged, be sufficiently filled or exhausted to meet the cleaning requirements of the surface a demanding environment. For example, in one embodiment, the effective droplet clearing of such surface may require (i) an average mass flow rate at nozzle target of at least about 0.5 g/s, or preferable about 1.0 g/s; (ii) nozzle outlet velocity at the target surface of greater than about 50 m/s, or preferably about 150 m/s; (iii) a target system thrust of at least about 0.025 N, or preferably greater than about 0.15 N (wherein thrust is equal to mass flow rate×velocity and a total impulse is thrust times a time of pulse).

Here, embodiments of the described systems may include at least one of the following design constraints: (i) that the sum of each of a nozzle outlet areas are the most restrictive portions of the system downstream of the dose; (ii) a minimum flow area of the solenoid valve may be less than the sum of each of the nozzle outlet areas; (iii) the cross sectional area of the tubes 62 or lumens that connect the nozzles with the QEVs are preferred to have a minimum dimension that is about 2 times the sum of the nozzle outlet areas fed by that tube section, and preferably a dimension that is about 5 times the sum of the nozzle outlet areas; and (iv) an area of the space 54 (FIG. 1A) between the valve member and the outlet port for the QEV should be greater area than the combined cross sectional areas of the tubes 62 connecting the QEV with the nozzle or nozzles. The space 54 may be measured by the equation [A=π×D×H]. In this equation, A is the area of the space 54, D is the diameter of the outlet port, and H is the distance that the valve member 50 moves away from a surface of the outlet port to be placed in a closed position.

These design parameters provide for efficiencies within the systems and allow for a target mas flow rate and anticipated operating pressure, speed of pressurized air in the tube to be less than 50 m/s and preferably less than about 10 m/s. Further, for a preferred efficient configuration, remaining absolute pressure in the dose chambers at the end of venting event should be greater than about 2 times ambient pressure (greater than 2 times bar absolute). This feature is configured to allow air to remain within the tube between the QEV and nozzle to be appropriately dense for low friction losses therein.

Applicant has discovered that during system operation, a thrust amount may drop to below target levels before dose pressure drops to ambient pressure levels. This is due to the decreasing system pressure and nozzle velocity over time as air is released. As such, air mass may be conserved by controlling the operation of the system in a “truncated cycle operation.” Here, the exhaust cycle of the QEVs may be controlled to be timed to occur around the same time that the thrust amount reaches or drops below a target level. This allows for some air pressure to remain in the dose chambers or within the tubing and QEVs of the system so that the time to refill a plurality of dose chambers may also be reduced thereby allowing for efficient and quick cyclical operation of the system. This also allows for pressure equilibrium to be maintained within the system while meeting or exceeding performance requirements relating to cleaning of target surfaces.

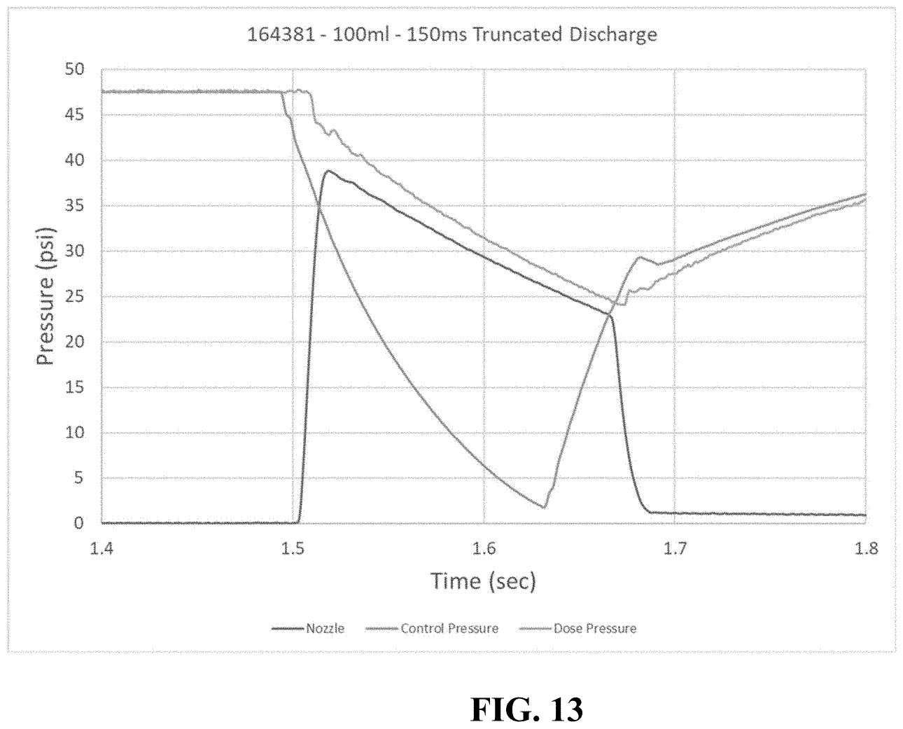

The “truncated cycle operation” is reflected in the graph identified in FIG. 13. Here, depicted is a pressure versus time graph that tracks a control pressure, nozzle pressure, and dose pressure for a single cycle of system operation at a single nozzle and single QEV. Static pressure of the system at both the control line (inlet port) and the dose chamber when the dose chamber is filled with pressurized air is reflected to be about over 45 psi. At the 1.5 second mark, the solenoid valve is switched from filling to venting and the control pressure begins to decrease from a static pressure of over about 45 psi. At this time, the valve member is toggled to open within the QEV due to the pressure imbalance across the valve member, pressurized air begins to be rapidly exhausted from the dose chamber to the outlet port and towards the nozzle wherein nozzle pressure increases to over 35 psi. There is a subtle delay between the decrease of the control pressure and the dose pressure wherein the dose pressure also begins to decrease from static pressure of over 45 psi after the opening of the QEV. The pressure decrease of the dose pressure and the nozzle appears to similarly decrease over this cycle phase until the control pressure is increased. The time that the control pressure is increased is before it reaches 0 psi but does not have to be. Notably, control pressure is increased as the solenoid valve is toggled to the fill position allowing air pressure to rise in the control line which then biases the valve member to close and allow the source of air pressure to be introduced back into the dose chamber. Here, it is preferable to toggle control line pressure when pressurized air is only partially exhausted and not completely exhausted from the dose chamber or from within the fluid lines of the system. This graph represents the time measured from about 1.4 seconds to about 1.8 seconds along the x-axis. Notably, as control pressure raises above the dose pressure, the valve member 50 toggles to the closed position.

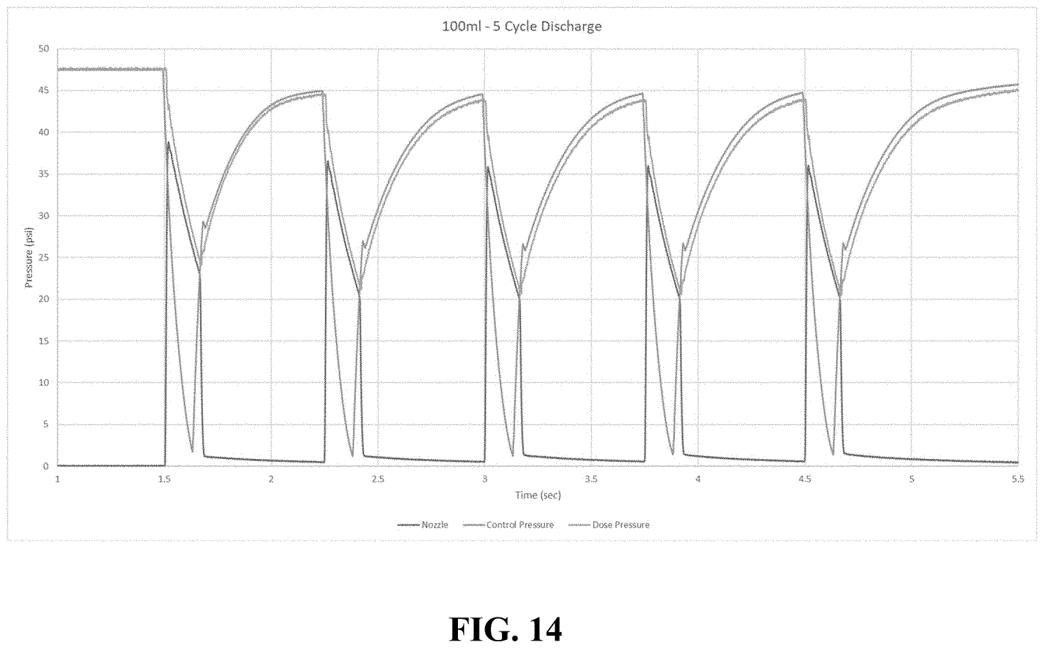

FIG. 14 illustrates another pressure versus time graph that represents cyclical operation of a truncated cycle of the systems described herein. Such operation may occur for surfaces that are experiencing heavy precipitation (such as storms or snow) and reflects continuous cycling while maintaining air pressure in the dose chamber, shortening fill times, and reducing air consumed by the system. Here, a 5 cycle discharge is represented wherein the initial exhausting of pressurized air occurs from static pressure (about over 45 psi). However, the truncated cycle as disclosed herein may operate continuously for the duration of a precipitation event sufficiently to provide continuous cleaning of the surface as may be needed for safe operation of a vehicle. Notably, the “truncated operations” occurs in subsequent bursts or discharges of pressurized air from the dose chamber/nozzle onto the surface to be cleaned. In practice, the nozzle of this system may express 5 bursts or pulses of pressurized air in under 5 seconds. The structure and arrangement of the QEVs, solenoid valve, nozzles, backflow valves as described above function to allow the performance of the truncated cycle to meet the design constraints of cleaning a target surface in a short amount of time with a system that takes minimal space while reducing the amount of pressurized air needed for such cleaning operation to be successful. Further, the structure and arrangement, as well as control of pressure equilibrium within the QEV as described herein act to reduce operational error, such as chatter, within the system.

Applicant has discovered that efficient filling of the dose chamber occurs most rapidly when there is a large pressure differential between the source of pressurized air and the pressure in the dose chamber. By reducing the amount of time to completely fill the dose chamber to a static pressure in subsequent cycles (i.e., by only filling the dose chamber to a lower peak dose pressure), it allows for faster cycling while still retaining most of the cleaning efficacy. Here the truncated operation is employed by toggling control pressure before pressurized air is both completely exhausted from and completely filled in the dose chamber during cyclic operation of the system. At least one of the following design features of the disclosed system may assist with efficiently operate a truncated cycle of the cleaning system thereby reducing error therein: (a) the at least one nozzle includes at least one outlet having a cross sectional area wherein the cross sectional area of the at least one outlet is greater than a cross sectional flow area of the changeover valve; (b) at least one tube connected between the exhaust valve and the at least one nozzle, wherein the tube includes a cross sectional area such that the cross sectional area of the tube is about 2 times a sum of the cross sectional area of the at least one outlet of the at least one nozzle; (c) the outlet port of the exhaust valve has a cross sectional area that is greater than the cross sectional area of said tube connected between the exhaust valve and the at least one nozzle; and/or (d) an absolute pressure in the dose chamber does not drop below about 2 times an ambient pressure as pressurized air is being exhausted from the dose chamber between exhaust air bursts. Notably, in FIG. 13 the dose pressure drops to around 25 psi and in FIG. 14 the dose pressure drops to between 20 psi to 25 psi before pressurized air is reintroduced into the system between pulses. Notably, it is desirable that dose pressure within the QEVs do not drop to 0 psi between each pulse to ensure rapid and error free operation.

In one embodiment, the solenoid valve is preferably sized to allow for refill of all dose chambers within the system within about 300 ms and preferably within about 200 ms. This may allow for a target cycle rate of about 3 Hz. Further, the control side rate of pressure change should be greater than the dose chamber rate of pressure change. This relationship allow the QEV to open fully and to prevent system “chatter.” The design limitations identified allow for any number of nozzles and QEVs but may be limited by the proportion of tube volume relative to dose volume.

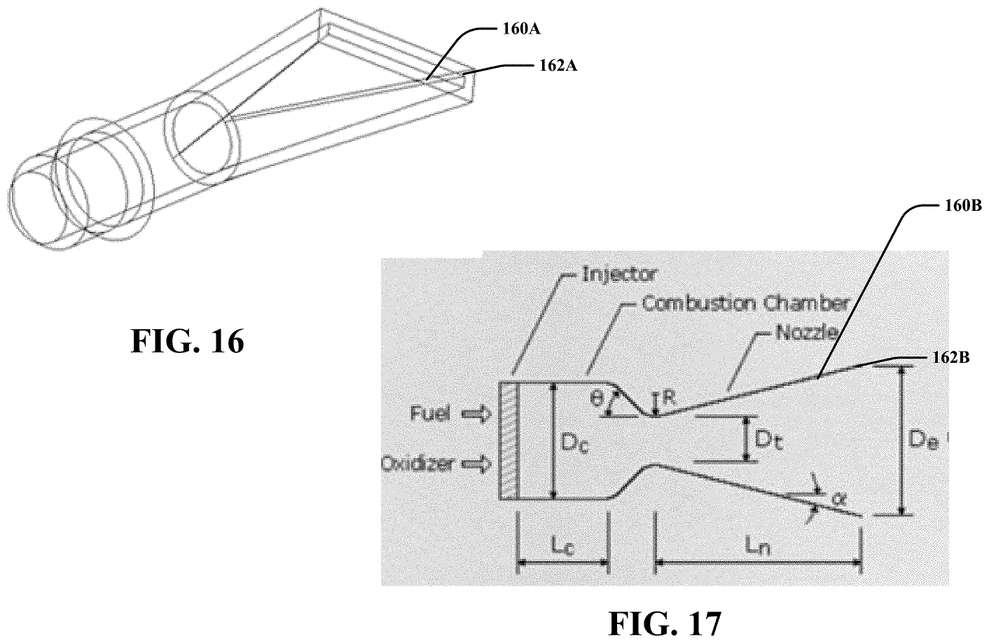

In one instance, the dose chamber may be a pilot valve as an alternative embodiment. Further, Applicant has identified that different nozzle configurations may effect the efficiency of the system. In one embodiment, an less efficient nozzle 160A (such as a shear nozzle) with a shear nozzle outlet 162B may be employed. See FIG. 16. In another embodiment, a more efficient nozzle 160B that includes an orifice outlet 162B having an axisymmetric converging-diverging (CD) nozzle configuration may be employed. See FIG. 17.

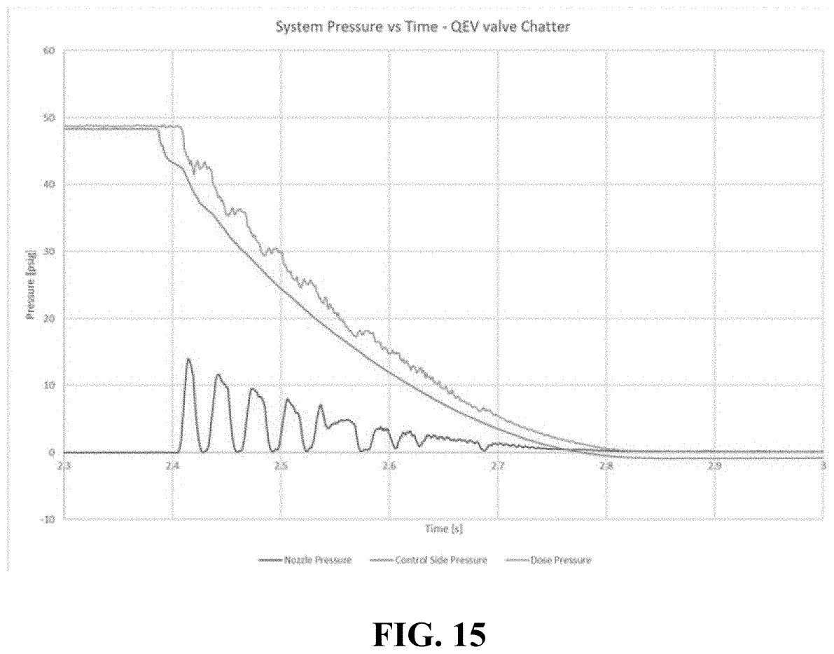

In one instance, “chatter” may occur in the system when a pressure equilibrium of the QEVs within the system becomes unbalanced during operation. Various forms of pressure chatter has been measured and can be viewed by the graph depicted in at least FIG. 15. This chatter has been found to exist if the equilibrium pressure within the QEVs fails to allow for the dose chambers to be filled, or exhausted in time for the successive filled/exhaustion of pressurized air to properly establish equilibrium.

Although the embodiments of the present teachings have been illustrated in the accompanying drawings and described in the foregoing detailed description, it is to be understood that the present teachings are not to be limited to just the embodiments disclosed, but that the present teachings described herein are capable of numerous rearrangements, modifications and substitutions without departing from the scope of the claims hereafter. The claims as follows are intended to include all modifications and alterations insofar as they come within the scope of the claims or the equivalent thereof.

Having thus described the invention, I claim:

1. A system for rapidly cleaning a surface along an exterior of a vehicle comprising:
at least one exhaust valves wherein the exhaust valve includes:
a housing that defines a cavity with an inlet port, a dose port, and an outlet port;
a dose chamber in communication with the dose port; and
a valve member placed within the cavity and configured to selectively communicate air pressure between the inlet port, the dose port, and the outlet port, wherein the valve member is configured to bias between a closed position and an open position, the cavity is divided into separate volumes by the valve member such that the selective bias of the valve member between the open and closed positioned allows pressurized air to be stored in the dose chamber and controlled to be expressed through the outlet port;
at least one nozzle in communication with the outlet port from the exhaust valve configured to express pressurized air onto a surface to be cleaned; and
a changeover valve in communication with the exhaust valve wherein the changeover valve is configured to selectively introduce pressurized air to said at least one exhaust valve and to selectively bias the valve member between the open and closed positions.

2. The system of claim 1, further comprising a plurality of exhaust valves in pressurized communication with a single changeover valve wherein each of the exhaust valves are in pressurized communication with at least one nozzle.

3. A system of claim 1, wherein the surface to be cleaned has a generally cylindrical shape.

4. The system of claim 3, wherein the generally cylindrical shape includes a height between about 25 mm to about 150 mm and a diameter of about 50 mm to about 300 mm.

5. The system of claim 1 wherein the dose port is attached to a dose chamber that is a separate volume continuous within the housing wherein the dose chamber is within the cavity of the housing.

6. The system of claim 1 wherein the dose port is attached to a dose chamber that is a separate volume attached to the housing and outside of the cavity of the housing.

7. The system of claim 1 wherein when the valve member is in the closed position, pressurized air may not be expressed from the outlet port but may be openly communicated between the inlet port and the dose port and when the valve member in the open position, pressurized air may be expressed from the dose port through the outlet port and not communicated with the inlet port.

8. The system of claim 1 wherein the exhaust valve is configured for rapid venting through the changeover valve to achieve quick opening of the valve member to release pressurized air from the dosing chamber to the outlet port.

9. The system of claim 8 wherein the changeover valve is a 3/2 solenoid valve such that the rapid venting is achieved through the solenoid valve.

10. The system of claim 1 further comprising at least one backflow valve in communication with at least one dose chamber and a source of pressurized air to allow for the rapid transfer of pressure from the source of pressurized air to the dosing chamber of said at least one exhaust valve when the valve member is in the closed position and the backflow valve is in the open position.

11. The system of claim 1 further comprising at least one backflow valve in communication between at least one dose chamber or at least one nozzle and a source of pressurized liquid to allow for the rapid transfer of pressured liquid to be mixed with pressurized air in said dose chamber or said nozzle.

12. The system of claim 2 wherein the plurality of exhaust valves are arranged in a series configuration relative to one another.

13. The system of claim 11 wherein the plurality of exhaust valves include a first exhaust valve and at least one subsequent exhaust valve, the system further comprising:
a first backflow valve in communication between at least one dose chamber of the at least one subsequent exhaust valve and the changeover valve such that the first backflow valve is configured to allow said dose chamber to be filled with pressurized air by a source of pressurized air when the changeover valve is open; and
a second backflow valve in communication between at least one inlet port of the at least one subsequent exhaust valve and the changeover valve such that the second backflow valve is configured to allow pressurized air into the at least one subsequent exhaust valve when the solenoid valve is open to toggle the valve member of the at least one subsequent exhaust valve in the closed position to allow the at least one dose chamber to be filled with pressurized air.

14. The system of claim 2 wherein the plurality of exhaust valves are arranged in a waterfall configuration relative to one another.

15. The system of claim 14 wherein the waterfall configuration includes a first exhaust valve and at least one subsequent exhaust valve such that the dosing chamber of the first exhaust valve is in fluid communication with the inlets port of the subsequent exhaust valve and are configured to route pressurized air from said inlet port of said subsequent exhaust valve to said dose chamber of the first exhaust valve.

16. The system of claim 14 further comprising:
a first backflow valve in communication between a dose chamber of a first exhaust valve, the changeover valve, the inlet port of the first exhaust valve; and
a second backflow valve in communication between a dose chamber of at least one subsequent exhaust valve, an inlet port of at least one subsequent exhaust valve wherein the first and second backflow valves allow the dose chambers to be filled with pressurized air by the air source when the changeover valve is opened;
wherein as the changeover valve is closed, the pressure within the dose chambers is configured to bias the valve members of the plurality of exhaust valves to the open position and exhaust pressurized air through the nozzles and against the desired surface; and
wherein pressurized air within the subsequent exhaust valve is configured to be rapidly exhausted from the inlet port of the subsequent exhaust valve to the dose chamber of the first exhaust valve, and pressurized air within the dose chamber of the first exhaust valve is configured to be rapidly exhausted from the outlet port.

17. The system of claim 1 wherein the system to is configured to provide a plurality of exhaust air bursts or pulsed air bursts from the at least one nozzle to clean a surface.

18. The system of claim 17 wherein between each of the plurality of pulsed air bursts, the dose chamber of the exhaust valve is filled with pressurized air to a static pressure and then the pressurized air is only partially exhausted from said dose chamber.

19. The system of claim 17 wherein the system further includes at least one of the following design features:
an average mass flow rate of each pulsed air burst is at least about 0.5 g/s;
a nozzle outlet velocity is greater than about 50 m/s; and
a target system thrust of that is greater than about 0.025 N.

20. The system of claim 17, wherein the system further comprises at least one of the following design features:
(a) the at least one nozzle includes at least one outlet having a cross sectional area wherein the cross sectional area of the at least one outlet is greater than a cross sectional flow area of the changeover valve;
(b) at least one tube connected between the exhaust valve and the at least one nozzle, wherein the tube includes a cross sectional area such that the cross sectional area of the tube is about 2 times a sum of the cross sectional area of the at least one outlet of the at least one nozzle;
(c) the outlet port of the exhaust valve has a cross sectional area that is greater than the cross sectional area of said tube connected between the exhaust valve and the at least one nozzle; and
(d) an absolute pressure in the dose chamber does not drop below about 2 times an ambient pressure as pressurized air is being exhausted from the dose chamber between exhaust air bursts.

21. A method of rapidly cleaning a surface utilizing a plurality of quick exhaust valves and a plurality of nozzles comprising:
providing at least one exhaust valve wherein the exhaust valve includes:
a housing that defines a cavity with an inlet port, a dose port, and an outlet port;
a dose chamber in communication with the dose port; and
a valve member placed within the cavity and configured to selectively communicate air pressure between the inlet port, the dose port, and the outlet port, wherein the valve member is configured to bias between a closed position and an open position, the cavity is divided into separate volumes by the valve member such that the valve member is configured to be selective biased between the open and closed positions;
providing at least one nozzle in communication with the outlet port from at least one of the plurality of exhaust valves configured to express pressurized air onto a surface to be cleaned;
providing a changeover valve in communication with the at least one exhaust valves; and
controlling the changeover valve to selectively introduce pressurized air to said at least one exhaust valve and to selectively bias the valve member between the open and closed positions to operate said exhaust valves in a truncated cycle operation to provide a plurality of exhaust air bursts or pulsed air bursts from the at least one nozzle to clean a surface.
